(19) United States
(12) Patent Application Publication
(10) Pub. No.: US 2004/0128666 A1
(43) Pub. Date: Jul. 1, 2004

(54) Distributed Dynamic Process Control System

(76) Inventor: Alex Elkin, Hudson, MA (US)

Correspondence Address: ALEX ELKIN, 111 BRIGHAM ST. UNIT 4E, HUDSON, MA, 01749, US

(21) Appl. No.: 10/707,371

(22) Filed: Dec. 9, 2003

Related U.S. Application Data
(63) Continuation of application No. 60/319,818, filed on Dec. 28, 2002.

(51) Int. Cl. G06F 9/44

(52) U.S. Cl. 717/171; 717/120; 717/121

(57) ABSTRACT

Process management system for highly distributed and dynamic processes comprising: an instance of a process schema been attached to a process data; a controller component capable of interpreting the process schema without the need for the centralized process management; an agent component capable of modifying the process schema for the given process instance; an agent component acting as interface between the process management and an execution system.

### BACKGROUND OF INVENTION

To provide users with the tools to implement the large software systems capable of evolving to support ever-changing business processes, many software vendors (for example: http://www.bpmi.org/members.esp) introduced what are widely known as Business Process Management (BPM) platforms.

A typical BPM solution separates the Process and the Activities that together comprise the total business process. Activities are the software modules that perform certain functions without explicit knowledge of each other. A business process, as defined by the Workflow standard—Terminology & glossary, Technical Report WFMC-TC-1011, Workflow Management Coalition, June 1996. Versions 2.0, is simply a set of one or more linked activities that collectively realize a business objective or a policy goal.

The Process is represented by the Process Schema or Process Definition that describes the order and conditions in which the Activities should perform to reach the desired results.

The Schema is executed by a special component often called a Process Server, Workflow Server, Conductor, etc. The functionality of the server includes managing the flow of the process between the activities.

This approach has severe limitations: all instances of a specific business processes follow the same Process Schema and this approach does not allow an individual instance to deviate from the standard Schema. Nevertheless, some business processes require exactly this type of behavior.

### DETAILED DESCRIPTION OF PREFERRED EMBODIMENT

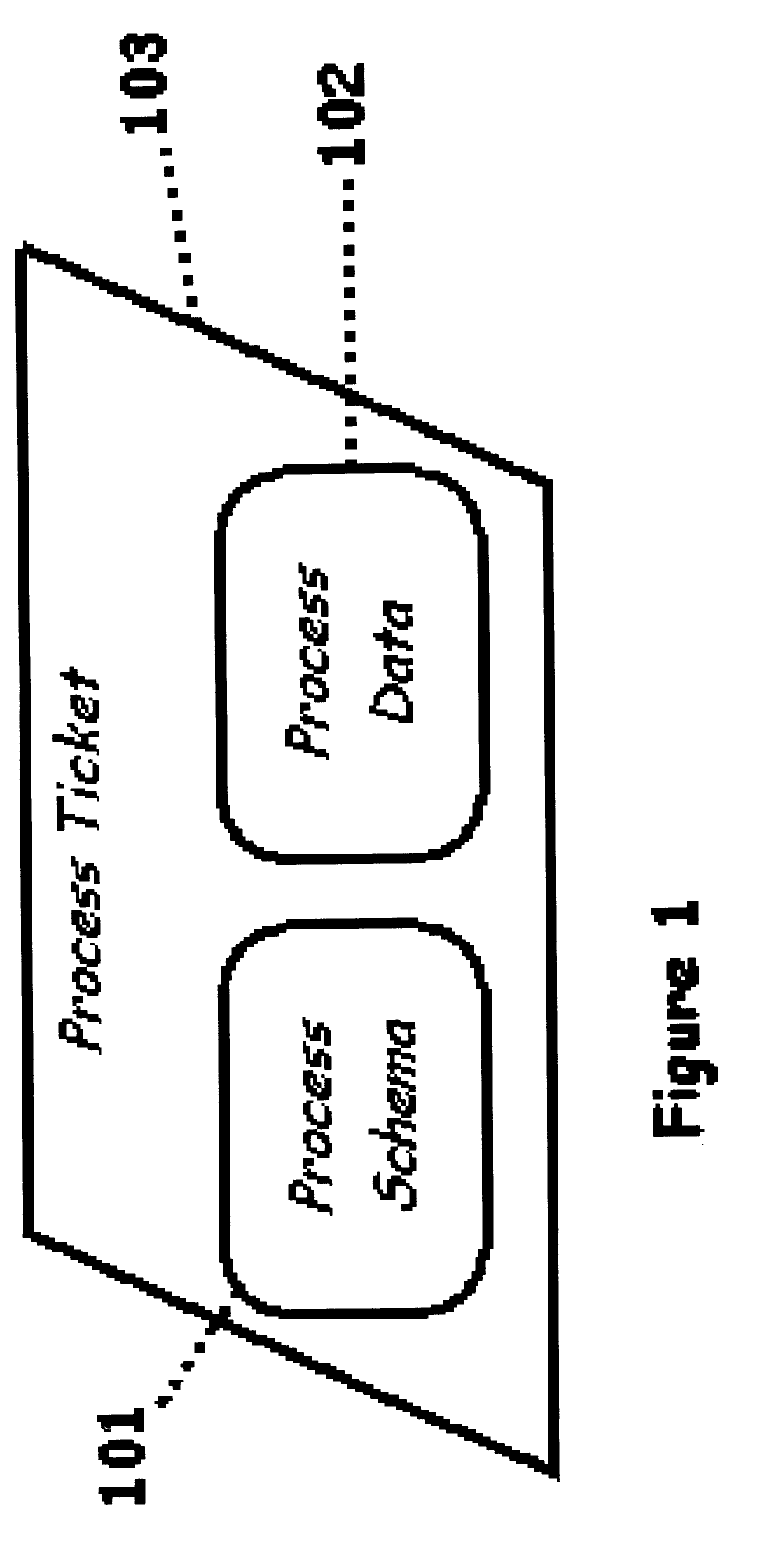

FIG. 1 illustrates how the present invention combines the Process Schema 101 as the symbolic description of what should be done to complete the business process, under what condition, and by what participants of the process, with the data 102 specific for the individual instance of the process. The result of the combination is the Process Ticket 103.

The Process Schema could be expressed in XML formatted structures such as BPEL4WS (http://www-106.ibm.com/developerworks/webservices/library/ws-bpel/), BPMN (http://www.bpmi.org/specifications.esp), ebXML (http://www.ebxml.org/), or any other data structure serving the same purpose.

The Process Data belongs to the specific instance of the Process. The data may describe a specific Customer Order, an Insurance claim, an Employee Status Change, an RFP (Request for Proposals) document or the data necessary to support any other business process or operation.

The data format depends on the nature of the data. It could be formatted as XML structures, or a Microsoft Word document, a bitmap or vector image file, an Electronic Data Interchange (EDI) document or other common or custom data format appropriate for the specific business process.

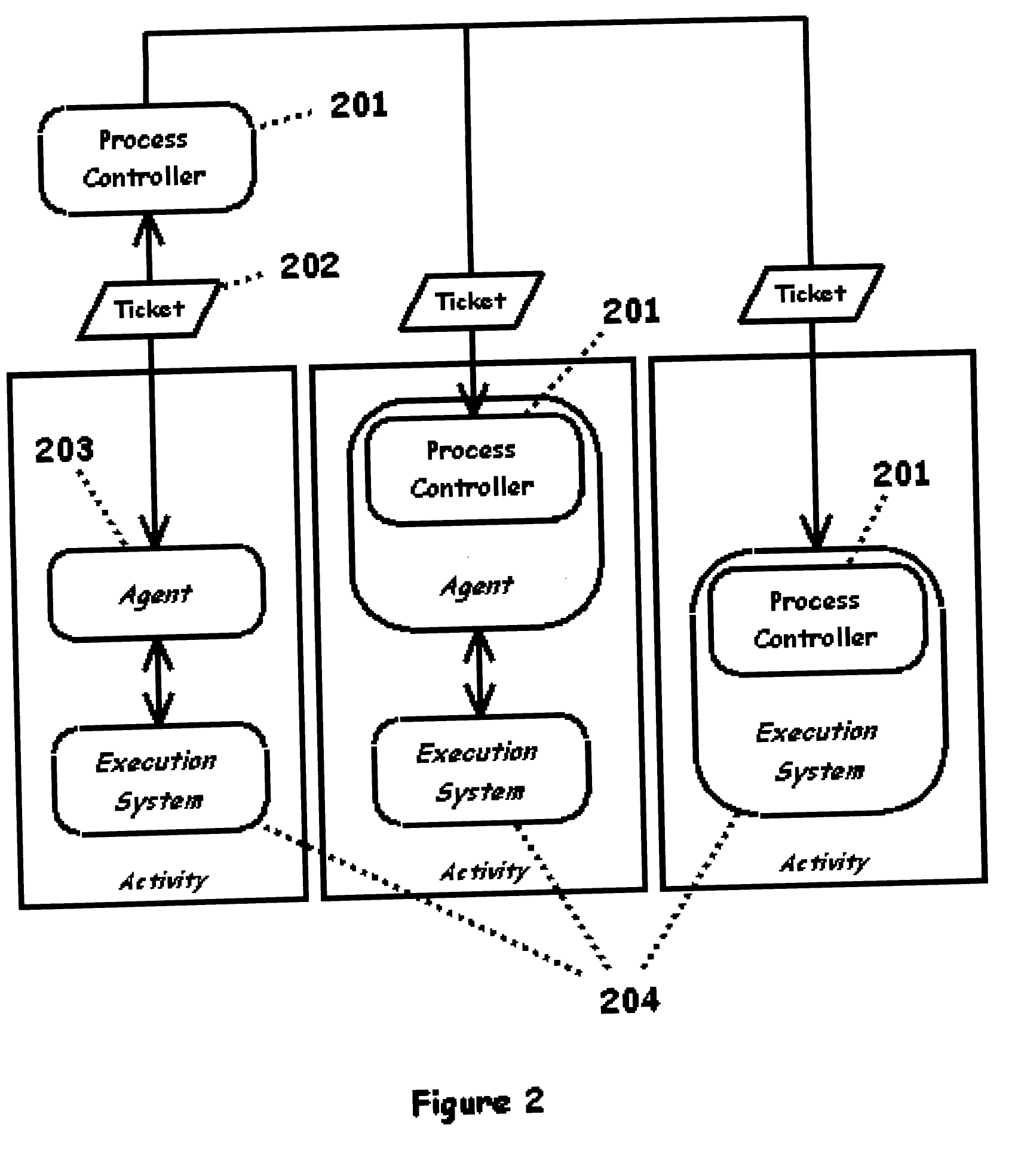

FIG. 2 illustrates the distributed system architecture. The system has one or more Process Controllers 201 (hereafter Controllers) that sends and receives the Process Tickets 202 (hereafter Tickets).

The Process Controller may be implemented as a separate server process, or as a part of another process such as an application server, or as a part of the Execution Agent 203, or as a part of the Execution System.

Execution System 204 is the software that actually performs the activity. It could be the general-purpose applications such as Microsoft Word or Microsoft Excel, specialized software systems such as ERP or CRM modules, or the software specifically developed for the process control system.

Controllers 201 communicate with other Controllers, Execution Agents 203, Execution Systems 204 via standard protocols such as SOAP, XML over HTTP, POP, SMTP, etc., as well as other standard and proprietary binary protocols.

The Controllers pass the Tickets to other Controllers, Agents and Execution Systems for execution and receives it back after the execution.

Agents act as the intermediary between the Controllers and the Execution System in those cases where the Execution System does not have an interface for the Controller. This may be the case with the third-party Execution Systems.

For example, if the Execution System is Microsoft Word, the agent is implemented as a plug-in component that converts the process data into Microsoft Word format (if necessary) and uses Microsoft Word to visualize it. If the data already exists in the Microsoft Word format, the Agent just extracts the data from the Ticket and passes it to the application.

In addition to interfacing the Execution System to the controller, the Agent also provides Common Process Services (CPS) to the Execution System. The Execution System may request process specific data such as: the participant of the process in the form of Users and Roles, system deadlines, the catalogs of other Execution Systems, etc.

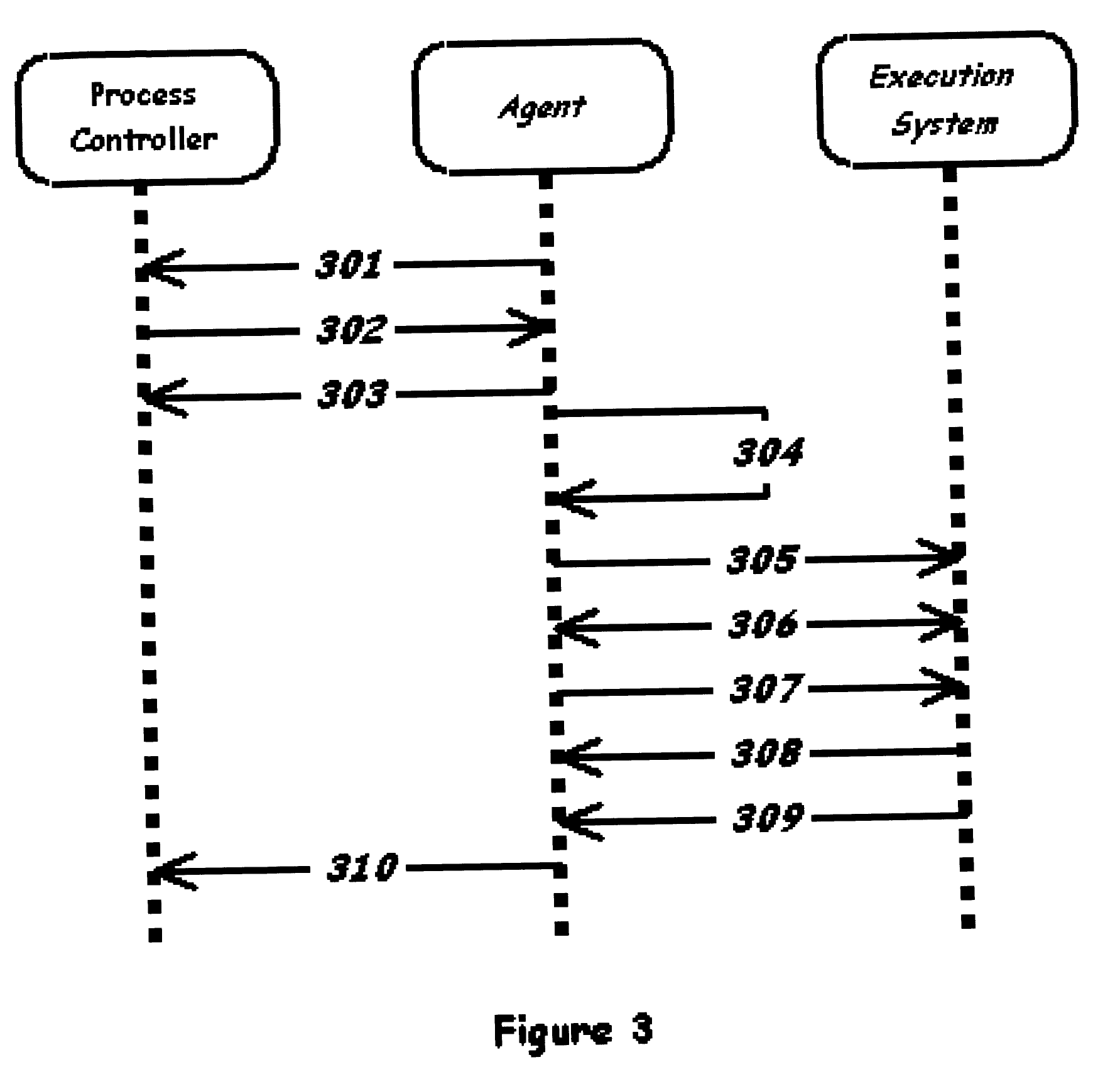

FIG. 3 illustrates the functionality of the Agent. In the most common case, the Agent:-301: Registers with the Controller for specific type of tickets; -302: Receives the Ticket from the controller;-303: Confirms the delivery of the ticket; -304: Converts the process data into the form suitable for the Execution System;-305: Passes the data to the Execution System;-306: Provides the Execution System with the common process services;-307: Provides the programming and user interface for modifications of the Process Schema;-308: Validates and authorizes the changes in the Schema; -309: Receives the completion report from the Execution System; -310: Sends the execution report along with the updated Ticket to the Controller.

During the execution of the ticket, the Schema may be changed either by the program logic or by a human user using a user interface provided by the Agent. Schema changes can include the addition and removal of activities and their attributes. The general attributes of the activities may include (but not limited to):

The data to be passed to the activity;

The execution system;

Deadline;

User or Role to be assigned to the activity;

The editing-related attributes of the activity define how much the activity can be changed during the process” execution. Among these attributes are:

Ability for the given user to change the Schema

Anchor activity that can not be removed from the Schema

Data can not be changed

Deadline can not be changed

Assignee can not be changed

Any changes in Schema are applied to the Master Process Schema. The Master Schema is the schema of the process prepared in advance and stored in the system. When the new instance of the process starts, the Master Schema is included in the Ticket.

The Master Schema may also be left incomplete. This forces the user of an activity to make changes in the related process instance in order for the Controller to determine the next step in the process execution.

The condition of incompleteness of the process schema is detected as an absence of the next step from any activity except the last one.

A process schema may have more than one condition of incompleteness.

A user of the activity may eliminate one or more conditions of incompleteness by explicitly defining the next step or steps. In this case the process continues until Controller detects the next condition of incompleteness.

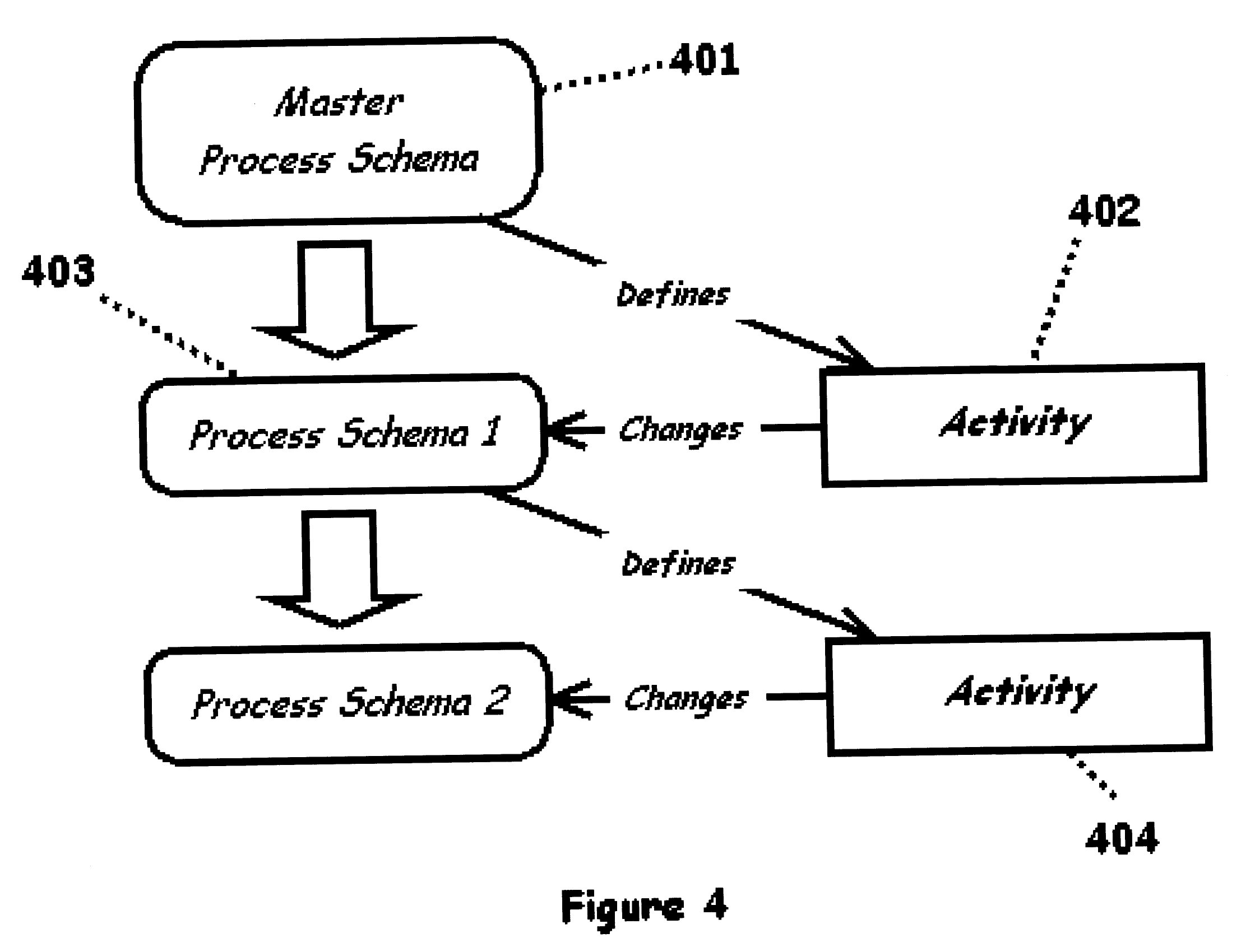

FIG. 4 illustrates the lifecycle of the process schema. It starts 401 as the Master Process Schema. An activity 402 makes the change in the schema. The modified schema 403 defines the next steps in the process. The following activity 404 makes more changes in the Schema.

1. A method for managing a process control in a distributed dynamic environment, the method comprising: including the process schema with the process data of an individual process instance, providing one or more controller components; providing one or more agent components.

2. A method according to claim 1 wherein the instance of the process schema is attached to the data that belongs to the individual process instance.

3. A method according to claim 2 wherein the process schema is represented in a format that can be interpreted or executed by the Process Controller software component. The Process Controller uses the instance of the schema to determine the next activity to be executed for this process instance.

4. A method according to claim 3 wherein the Process Controller does not require any previously implemented, coded, scripted, or any other information about the process schema beyond the one that comes with the process instance.

5. A method according to claim 2 wherein the process schema can be modified by the Agent software component as a part of one or more of the activities in the process.

6. A method according to claim 5 wherein the Agent component provides programming and user interface for modifications of the process schema instance.

7. A method according to claim 6 wherein the process schema may contain restrictions on the modifications.

8. A method according to claim 2 wherein the schema may contain one or more conditions of incompleteness defined as an absence of the next step in the process. When a Controller reaches such a point of incompleteness it forces the user of an activity to eliminate the incompleteness by explicitly defining the next step or steps.

9. A method according to claim 2 wherein the Agent component provides interface between the Controller and the Execution System. The interface includes the ability to convert the process data into a form suitable for a specific Execution System.

10. A method according to claim 9 wherein the Agent component could be implemented as a plugin into the Execution System.

11. A method according to claim 3 wherein a Process Controller component uses the instance of the process schema and the process instance data to determine the next step in the process execution therefore eliminating the need to place the process schema in the scope of the Process Controller in advance and allowing different instances of the process to have different next steps.

12. A software system for enabling a user to change the process schema for the given instance of the process without making any changes in the software system implementation or deployment.

13. A software system according to claim 12 comprising: one or more Process Controllers and one or more Agents; the system may have pre-existing Master Process Schema for every possible type of process.

14. A software system according to claim 13 wherein the Process Controller determines the next step in the process execution and sends the process data and process schema to the Agent.

15. A software system according to claim 14 wherein the Agent converts the process data into a form suitable for the Execution System and provides the programming and user interface for modifying the process schema instance.
